(19) United States
(12) Patent Application Publication
(10) Pub. No.: US 2008/0310141 A1
(43) Pub. Date: Dec. 18, 2008

(54) VEHICLE INSTRUMENT CLUSTER

(76) Inventor: Samir Mezouari, Basildon (GB)

Correspondence Address: FRASER CLEMENS MARTIN & MILLER LLC, 28366 KENSINGTON LANE, PERRYSBURG, OH, 43551, US

(21) Appl. No.: 12/118,045

(22) Filed: May 9, 2008

(30) Foreign Application Priority Data
Jun. 12, 2007 (GB) 0711311.1

(51) Int. Cl. G01D 11/28; B60Q 3/04

(52) U.S. Cl. 362/30; 362/489; 362/26

(57) ABSTRACT

A backlit display unit comprising a user display for displaying information to a user of the unit, the user display having a display medium and a movable display device with a movable indication, a common source of illumination for backlighting the user display, at least one light diffuser for diffusing light incident thereon and a carrier, the carrier supporting the illumination source, the carrier having opposite first and second surfaces. The movable indication and the display medium are provided on the first side of the carrier. The light diffuser is provided on the second side of the carrier. The arrangement is such that illumination from the illumination source is incident upon the light diffuser, and the incident light is diffused by the light diffuser back towards the movable indication and the display medium to provide backlit illumination for both the movable indication and the display medium.

### CROSS-REFERENCE TO RELATED APPLICATION

This application claims priority to United Kingdom Patent Application No. 0711311.1, filed Jun. 12, 2007, the entire disclosure of which is hereby incorporated herein by reference.

### FIELD OF THE INVENTION

The present invention relates to the field of lighting displays, and more particularly to the backlighting of displays

### BACKGROUND OF THE INVENTION

Displays are often provided with backlighting, which provides illumination through clear or translucent portions of components forming the display. Examples include liquid crystal display (LCDs), or indication displays having an appliqué with transparent or translucent portions through which the illumination passes.

Examples in the field of automotive displays include LCD displays for displaying alphanumeric or graphical information and speedometer or engine speed (rpm) displays having translucent numeric indications.

Traditionally, such displays have been illuminated with incandescent bulbs. With the emergence of solid state light sources, there has been a considerable increase in the usage of light emitting diodes (LEDs) as display illumination, particularly white LEDs, because of their compact size and long lifetime.

The display is usually part of a display module seated inside a dashboard assembly. The depth for the display module may be limited because of the space required behind the display for wiring or ducting, and in any event it is desirable to limit the depth of the display.

Display modules comprise normally of a rigid or flexible printed circuit carrier, for example a printed flex strip or a rigid printed circuit board (PCB) with conduction tracks and components on one or both sides. In order to provide even backlight illumination over an area of the display, it may be necessary to use two or more lights spaced across the display. When incandescent bulbs are used, use of multiple bulbs may also be desirable to provide some overlap between the illumination provided by the bulbs so that when one bulb fails, a portion of the display does not go completely dark.

However, white LEDs are considerably more expensive than incandescent bulbs, and so it is almost always uneconomical to simply replace each incandescent light with an LED. The process of manufacturing white LEDs also leads to some inevitable hue variation in the shade of white produced by different LEDs. This can lead to unpredictable color variations across a backlit display.

Therefore, the use of LEDs in backlit display applications has in practice been limited to small area displays both for reasons of cost and for color uniformity.

It is an object of the present invention to provide a more convenient backlit display, which deals with at least some of these limitations.

### SUMMARY OF THE INVENTION

According to the invention, there is provided a backlit display unit comprising a user display for displaying eye visible information to a user of the unit, the user display having a display medium and a movable display device with a movable indication for providing indications on the display medium to the user, a source of illumination for backlighting the user display, at least one light diffuser for diffusing light incident thereon and a carrier, the carrier supporting the illumination source and the carrier having opposing first and second surfaces, wherein: the movable indication and the display medium are both provided on the first side of the carrier, the light diffuser is provided on the second side of the carrier, the arrangement is such that illumination from the illumination source is directed to be incident upon the light diffuser, and the incident light is diffused by the light diffuser back towards the movable indication and the display medium to provide backlight illumination for the both the movable indication and the display medium.

Also according to the invention, there is provided a method of providing diffuse backlit illumination to a display unit, the display unit comprising a user display, a source of illumination, one or more light diffusers, the user display having a display medium and a movable display device that has a movable indication, wherein the method comprises: using the light source to generate a source of illumination for backlighting the user display; directing illumination from the source away from the display medium and away from the movable indication to fall upon the light diffuser; redirecting the illumination falling on the light diffuser to provide backlight illumination to both the display medium and the movable indication in order to provide to a user eye visible information from both the display medium and movable indication.

The invention also provides a display assembly comprising a backlit display unit and a rear cover, in which the backlit display unit is in accord with the invention, and at least a portion of the light diffuser is provided by the rear cover.

The source of illumination may be any type of light source suitable for back illumination of a display, but preferably includes at least one solid state light emitter.

The displayed information may be any type of information needed by user of the unit, for example alphanumeric information, a gauge or dial markings, graphical symbols, or warning indicators.

The carrier may include conductors for conveying electrical current to the source of illumination. The carrier may be any suitable type of carrier, but is preferably a printed circuit board carrier, for example a flexible printed circuit strip, or a molded printed circuit board. In a preferred embodiment of the invention, the carrier is a glass fiber printed circuit board.

In another embodiment of the invention, the source of illumination is a single light source, for example a solid state light source. This could be a visible laser diode but is preferably at least one LED, for example colored LEDs grouped together to form a white LED or to achieve a user-defined color.

In another embodiment of the invention, a single white LED is positioned centrally with respect to the display medium. The use of a single white LED avoids problems with color matching of multiple white LEDs and also helps to reduce manufacturing costs as opposed to a display having multiple white LEDs.

The source of illumination may be supported by the carrier, adjacent an edge to a surface of the carrier. The distance between the carrier and the diffuser, the distance from the diffuser to the carrier, and the distance from the carrier to the display medium may be selected to substantially provide even backlit illumination.

The carrier may be a substantially planar carrier, the display medium including a substantially planar display surface, and the carrier being parallel with the display surface.

The carrier may include one or more edges past which at least a portion of the illumination is diffused back towards the display medium. Similarly, at least a portion of the illumination may be diffused back towards the movable indication past one or more of such edges.

The movable indication and the display medium may have different diffusers, or may share a common diffuser. When there is a common diffuser, this may be a portion of a reflective or a light scattering light box disposed on the second side of the carrier, and this portion may be a central portion of the light box.

In yet another preferred embodiment of the invention, the movable display device is a rotational display device, which includes a light pipe positioned on a rotational axis of the display device. The light pipe extends in a direction from the second surface of the carrier to the first surface of the carrier.

Preferably, the movable indication and the display medium share a common diffuser. The light pipe can then be arranged to receive backlit illumination for the movable indication from the common diffuser.

The diffuser for the movable indication may include at least one surface of the light pipe which is opaque or reflective to light incident on the surface, and this surface may include an end face of a substantially cylindrical light pipe. The light pipe may extend from the movable indication in a direction perpendicularly to a plane defined by the carrier.

The light diffuser may include a light scattering light box disposed on the second side of the carrier, in which case the light box may extend annularly around a rotational axis of the rotational display device. The light box may include a substantially conical central light scattering or light reflecting surface opposing the second side of the carrier, in which case, a central part of this conical surface may be arranged to direct light incident on this central part of the conical surface t back towards the movable indication to provide backlight illumination for the movable indication.

### BRIEF DESCRIPTION OF THE DRAWINGS

The above, as well as other advantages of the present invention, will become readily apparent to those skilled in the art from the following detailed description of embodiments of the invention when considered in the light of the accompanying drawings in which:

FIG. 1 is a front elevational view of a vehicle dashboard display assembly, comprising a central main display unit according to the invention;

FIG. 2 is a schematic side cross sectional view of a backlit display unit, according to an embodiment of the invention; and

FIG. 3 is a schematic side cross sectional view of a backlit display unit, according to another embodiment of the invention.

### DETAILED DESCRIPTION OF EXEMPLARY EMBODIMENTS OF THE INVENTION

The following detailed description and appended drawings describe and illustrate an embodiment of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

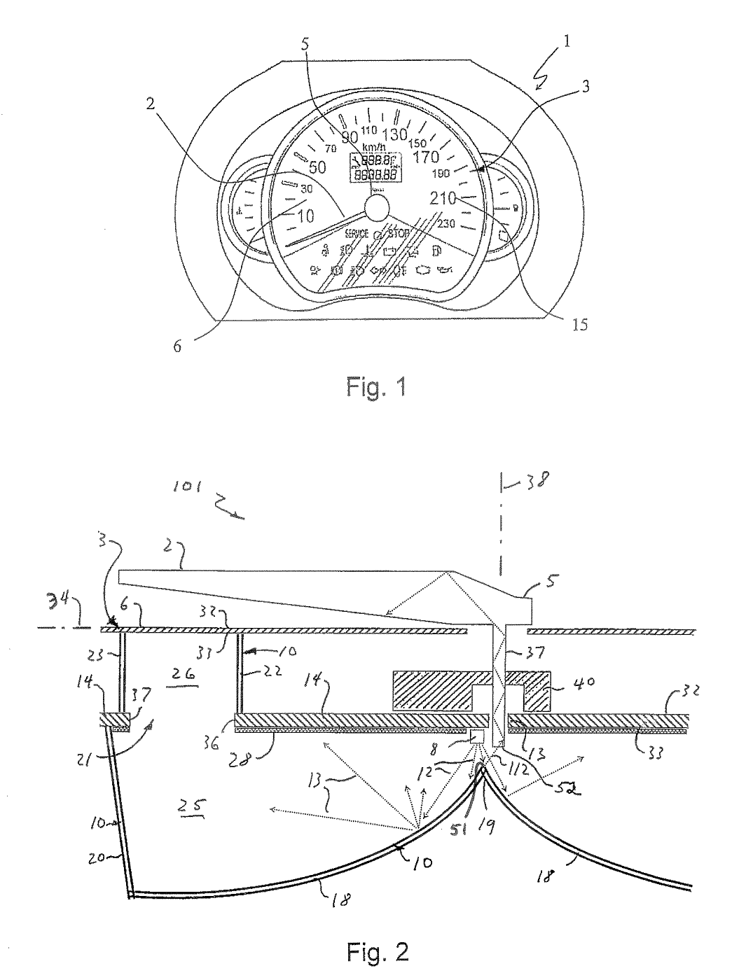

With reference first to FIG. 1, a vehicular dashboard display assembly 1 includes a number of display units, including a central dial display 3, which in this example is a speedometer display. The display 3 is backlit so that user can see alphanumeric or graphical information 15 presented by a partially translucent display medium 6 and the position of a speed indicator 2 which rotates about a central hub 5 on the display 3.

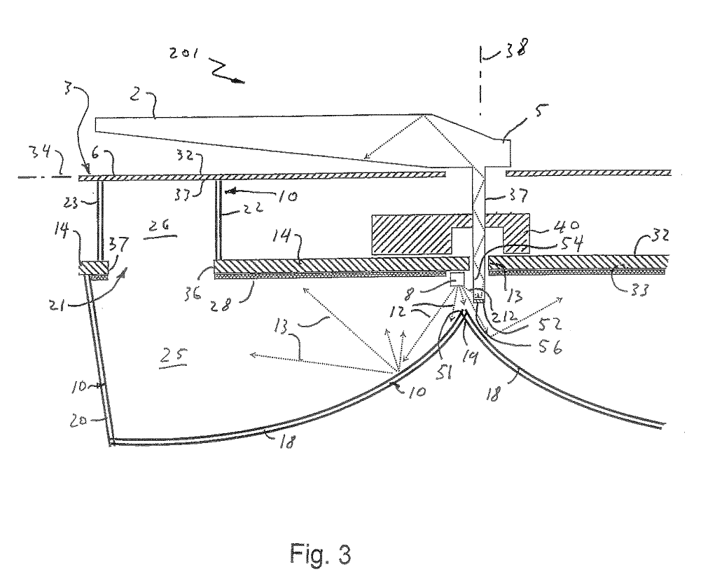

FIGS. 2 and 3 show schematically the workings of two specific embodiments 101, 201 of the display assembly. Each embodiment has the partially translucent display medium 6 for displaying eye visible information to a user of the unit, an LED light source 8 for backlighting the display medium 6, an annular light diffuser 10 for diffusing light 12 incident on the diffuser, and a printed circuit board (PCB) carrier 14 which supports the source of illumination 8. The diffuser 10 is typically formed from a substantially opaque white plastic material.

The source of illumination is provided by a single white LED 8 mounted near a central aperture 13 of the printed circuit board carrier 14.

The light diffuser 10 is spaced apart from the display medium 6. The display medium 6 is substantially in an intermediate orientation with respect to the light diffuser 10 and the display medium 6.

The light diffuser 10 is an open box type light diffuser, having an annular base 18 having a central conical peak 19 from which a concave shaped surface extends towards an essentially cylindrical outer side wall 20, which in turn extends upwards from the base 18 towards the printed circuit board carrier 14 in the direction of the display medium 6. Aligned above the side wall 20 and an annular aperture 21 in the printed circuit board carrier 14 is a continuation of the light box for conveying diffused light to the display medium 6, in the form of a pair of concentric inner and outer cylindrical walls 22, 23, also typically formed from white plastic. The light box 10 is therefore divided horizontally into a lower portion 25 and upper portion 26 by the PCB carrier 14 which extends in a substantially parallel plane with and intermediate a plane defined by the display medium 6 and the diffuser base 18. The use of the upper portion 26 of the light diffuser 10 is optional. The base 18 (and optionally parts of the lower side wall 20) provide initial diffusing of incident light 12, which is then scattered to be multiply incident on other wall portions 20, 22, 23 of the light box, which also includes a white painted lower surface 28 of the PCB carrier 14. The upper wall portions 26 therefore provide a secondary diffusing of light. Because the illumination from the LED 8 is directed downward, away from the PCB carrier 14, a majority of the light 12 from the light source 8 is incident on the diffuser base 18.

The annular aperture and numerical backlit indicia 15 extend over an arc of about 270°, around the display 3.

The PCB carrier 14 has opposite first and second surfaces 32, 33. The first surface 32 is generally oriented towards the display medium 6 and the second surface 33 is generally oriented towards the base 18 of the light diffuser 10. The first and second surfaces 32, 33 therefore define a plane 34 that extends between the light diffuser base 10 and the display medium 6.

The PCB surfaces 32, 33 include an inner aperture 13 and the annular aperture 21 bound by inner and outer edges 36, 37. The source of illumination 8 is supported on the PCB lower surface 33 directly adjacent the central aperture 13. In both embodiments 101, 201, this is so that some light from the LED 8 can enter a transparent cylindrical light pipe 37, which extends downwards along an axis 38 of rotation of the movable pointer 2.

Alternatively, the source of illumination 8 could be supported on the first PCB surface 32, and with the emitter surface still directed downwards, if the PCB 14 were therefore shaped or perforated (not shown) to permit light emitted by the light source 8 to be directed downwards towards the light diffuser base 18.

The PCB carrier includes on the first surface 32 conductive tracks (not shown) to convey electrical power to the source of illumination 8. An advantage of this arrangement is that the PCB need only be single-sided, as other display components, connectors or circuitry can be provided on the same side of the PCB. In this example, the rotational pointer 2 is driven by a motor 40 provided on the opposite side from the LED light source 8, and so conductive tracks (not shown) can also be provided to this motor along the first side 32 of the PCB 14. A further advantage is that the second surface 33 of the PCB 14 can be painted white 28 without interfering with any conductive tracks.

The light pipe 37 is typically integrally formed of a transparent plastic material with the rotational pointer 2. The hub 5 is shaped to direct any light which enters the light pipe 37 upwards into the pointer 2, which light exits to make the pointer 2 visible to a user of the display. In both embodiments 101, 201, a portion of light 112, 212 from the LED 8 used to illuminate the display medium 6, is directed up into the light pipe 37. In the first embodiment 101, a central conical tip 51 of the back surface 18, is used to scatter this light portion 112 back into a lowermost end surface 52 of the light pipe 37, after which the light is conveyed to the pointer 2. The tip 51 may be somewhat rounded or flattened to aid scattering of light towards the light pipe 37.

In the second embodiment 201, light 212 from the LED 8 enters a side wall 54 of the light pipe 37, and initially travels away from the PCB second surface 33 until being scattered in the opposite direction towards the rotational pointer hub 5 and pointer 2, by means of a white paint 56 on the lowermost end surface 52 of the light pipe. To increase the amount of light reflected towards the light pipe 37, a high-reflection coating 56 can be applied on the lowermost end surface 52 of the light pipe.

Both these embodiments 101, 201 benefit from having a single LED 8 centrally positioned with respect to the display medium 6. The light box diffuser 10 is open fully from the side wall 20 to the centre, and is circularly symmetric over the arc of the display medium 6 so that that incident illumination 12 is directed evenly around the circumference of the display medium 6. This central positioning of the LED 8 also facilitates the introduction of a portion of the illumination 112, 212 into the pointer light pipe 37 for illuminating the pointer. This results in a decrease in the complexity and cost of the lighting arrangement, and, in the case of a white LED, an improvement in the white color balance of the display assembly 1, 101, 201.

It should be understood that the invention is compatible with the use of other light diffusers, for example, a diffuser could be directly affixed to the light source element optical output facet or lens, or a diffuser screen or paint could be directly behind or in contact with the display medium.

A particular advantage of the invention is that the diffuser base 18 may be an integral part of a rear cover to the display assembly 1, 101, 201. Such covers are often provided with automotive display assemblies in order to protect display components such as a PCB, integrated circuits or other electrical components.

Compared with conventional backlight systems, in which illumination from diffused backlights is directly incident on the display medium, the invention provides good diffusing of light from a reduced number of backlight elements. This is useful when the elements are individual light sources, particularly individual white or colored light emitting diodes. The invention therefore provides a convenient and economical backlit display.

From the foregoing description, one ordinarily skilled in the art can easily ascertain the essential characteristics of this invention and, without departing from the spirit and scope thereof, make various changes and modifications to the invention to adapt it to various usages and conditions.

I claim:

1. A backlit display unit comprising:
a carrier having a first surface and a second surface;
a user adjacent the first surface of said carrier including a display medium;
a source of illumination disposed on said carrier; and
a light diffuser adjacent the second surface of said carrier, wherein light from said source of illumination incident on said light diffuser is directed towards the display medium thereby providing a backlight illumination for the display medium.

2. A backlit display unit according to claim 1, wherein said source of illumination is one of a single light source, a solid state light source, and a single light emitting diode.

3. A backlit display unit according to claim 1, wherein said carrier includes an aperture formed therein, wherein a portion of the light from said source of illumination is directed through the aperture and towards one of the display medium and a movable display disposed on said user display.

4. A backlit display unit according to claim 3, wherein said light diffuser diffuses light to both the movable indication and the display medium.

5. A backlit display unit according to claim 1, further comprising a light scattering light box adjacent on the second surface of said carrier, incorporating said light diffuser.

6. A backlit display unit according to claim 5, wherein said light diffuser forms a central portion of said light scattering light box.

7. A backlit display unit according to claim 3 wherein the movable display device is a rotational display device.

8. A backlit display unit according to claim 7, wherein the movable display device includes a light pipe extending in a direction from the second surface of said carrier to the first surface of said carrier.

9. A backlit display unit according to claim 8, wherein said light diffuser diffuses light to the movable indication, the display medium, and the light pipe.

10. A backlit display unit according to claim 8, wherein said light diffuser further includes a lower surface of the light pipe, the lower surface being one of opaque and reflective.

11. A backlit display unit according to claim 10, wherein the lower surface of the light pipe includes a cylindrical end face.

12. A backlit display unit according to claim 8, wherein the light pipe is arranged perpendicularly to said carrier.

13. A backlit display unit according to claim 7, further comprising a light scattering light box adjacent on the second surface of said carrier incorporating said light diffuser.

14. A backlit display unit according to claim 1, wherein said light diffuser is a substantially conical light diffuser.

15. A backlit display unit according to claim 1, wherein said carrier includes a conductor for conveyance of an electrical current to said source of illumination.

16. A backlit display unit according to claim 1, wherein said carrier is a printed circuit board carrier.

17. A display assembly comprising:
a backlit display unit including a carrier having a first surface and a second surface, a user display including a display medium having indications and a movable display device having a movable indication, the user display adjacent the first surface of said carrier, and a source of illumination disposed on the carrier; and
a base adjacent the second surface of said carrier including a light diffuser, wherein light from the source of illumination incident on the light diffuser is directed towards the movable indication and the display medium to provide a backlight illumination thereof.

18. A display assembly according to claim 18, wherein the source of illumination is one of a single light source, a solid state light source, and a single light emitting diode.

19. A method of providing diffuse backlit illumination to a display unit, comprising the steps of:
providing a carrier having a first surface and a spaced apart second surface;
providing a user display including a display medium having indications and a movable display device having a movable indication, said user display adjacent the first surface of said carrier;
providing a source of illumination on said carrier;
providing a light diffuser adjacent the second surface of said carrier;
directing light from said source of illumination to said light diffuser; and
redirecting light from said light diffuser to provide backlight illumination for the movable indication and the display medium.
